(19) United States
(12) Patent Application Publication
(10) Pub. No.: US 2009/0138889 A1
(43) Pub. Date: May 28, 2009

(54) METHOD AND APPARATUS FOR EXPOSING INFORMATION TECHNOLOGY SERVICE MANAGEMENT PROBLEMS TO A SYSTEMS MANAGEMENT SYSTEM

(76) Inventors: Rhonda L. Childress, Austin, TX (US); David Bruce Kumhyr, Austin, TX (US); Stephen James Watt, Cedar Park, TX (US)

Correspondence Address: IBM CORP (YA);C/O YEE & ASSOCIATES PC, P.O. BOX 802333, DALLAS, TX, 75380, US

(21) Appl. No.: 11/946,723

(22) Filed: Nov. 28, 2007

(51) Int. Cl. G06F 9/46

(52) U.S. Cl. 718/106

(57) ABSTRACT

The illustrative embodiments described herein provide a computer implemented method, apparatus, and computer program product for exposing information technology service management problems associated with a particular data processing system to a systems management system. A ticket identifier is received by a data processing system. The ticket identifier identifies a reported problem associated with the data processing system. Responsive to receiving the ticket identifier, the data processing system identifies a systems management system application associated with the data processing system. A generated message containing the reported problem associated with the data processing system is sent to the systems management system.

### CROSS-REFERENCE TO RELATED APPLICATIONS

The present application is related to the following applications entitled “METHOD AND APPARATUS FOR ASSOCIATING HELP DESK TICKET WITH AFFECTED DATA PROCESSING SYSTEM”, Ser. No. ______, attorney docket no. AUS920070020US1; and “METHOD AND APPARATUS FOR GENERATING STATISTICS ON INFORMATION TECHNOLOGY SERVICE MANAGEMENT PROBLEMS AMONG ASSETS”, Ser. No. ______, attorney docket no. AUS920060699US1; filed on even date hereof, assigned to the same assignee, and incorporated herein by reference.

### BACKGROUND OF THE INVENTION

1. Field of the Invention

The present invention relates generally to the data processing field. Still more particularly, the present invention relates to a computer implemented method, apparatus, and computer program product for exposing information technology service management problems to a systems management system.

2. Description of the Related Art

Information technology service management (ITSM) is a discipline for managing information technology (IT) systems. Information technology service management focuses on providing customer satisfaction in regards to the use of information technology. A service facility, also known as a help desk, is a primary component of information technology service management.

Many organizations provide service facilities to address customer problems. The service facility generally utilizes a help desk software system for keeping track of service calls and for generating a report, generally referred to herein as a “help desk ticket”, that identifies the individual reporting the problem and the data processing system affected by the problem. At an appropriate time, a service person, referencing the help desk ticket, will correct the reported problem, either directly from the help desk, if possible, or by traveling to the location of the affected data processing system.

Many organizations also utilize a systems management system to monitor and manage the information technology infrastructure of the organizations. A systems management system, such as, but not limited to, Tivoli® Business Systems Manager (TBSM) provides information about individual components or resources within the information technology infrastructure of the organization. For example, Tivoli® Business Systems Manager shows operation personnel what business functions are affected by an outage of a single component, such as, but not limited to, a specific server within the infrastructure. Tivoli® Business Systems Manager (TBSM) is a registered trademark of International Business Machines Corporation.

Currently, a disconnect exists between the information generated by the help desk system and the systems management system monitoring the assets within an organization. Accordingly, it would be advantageous to have a computer implemented method, apparatus, and computer program product for overcoming the problems discussed above.

### SUMMARY OF THE INVENTION

The illustrative embodiments described herein provide a computer implemented method, apparatus, and computer program product for exposing information technology service management problems associated with a particular data processing system to a systems management system. A ticket identifier is received by a data processing system. The ticket identifier identifies a reported problem associated with the data processing system. Responsive to receiving the ticket identifier, the data processing system identifies a systems management system application associated with the data processing system. A generated message containing the reported problem associated with the data processing system is sent to the systems management system. Thereby, exposing information technology service management problems associated with a particular data processing system to a systems management system application.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an exemplary embodiment when read in conjunction with the accompanying drawings, wherein:

FIG. 1 is a pictorial representation of a network of data processing systems in which exemplary embodiments may be implemented;

FIG. 2 is a block diagram of a data processing system in which exemplary embodiments may be implemented;

FIG. 3 is a block diagram of a data processing environment in accordance with an illustrative embodiment; and

FIG. 4 is a flowchart of a process for exposing information technology service management problems to a systems management system in accordance with an illustrative embodiment.

### DETAILED DESCRIPTION OF THE PREFERRED EMBODIMENT

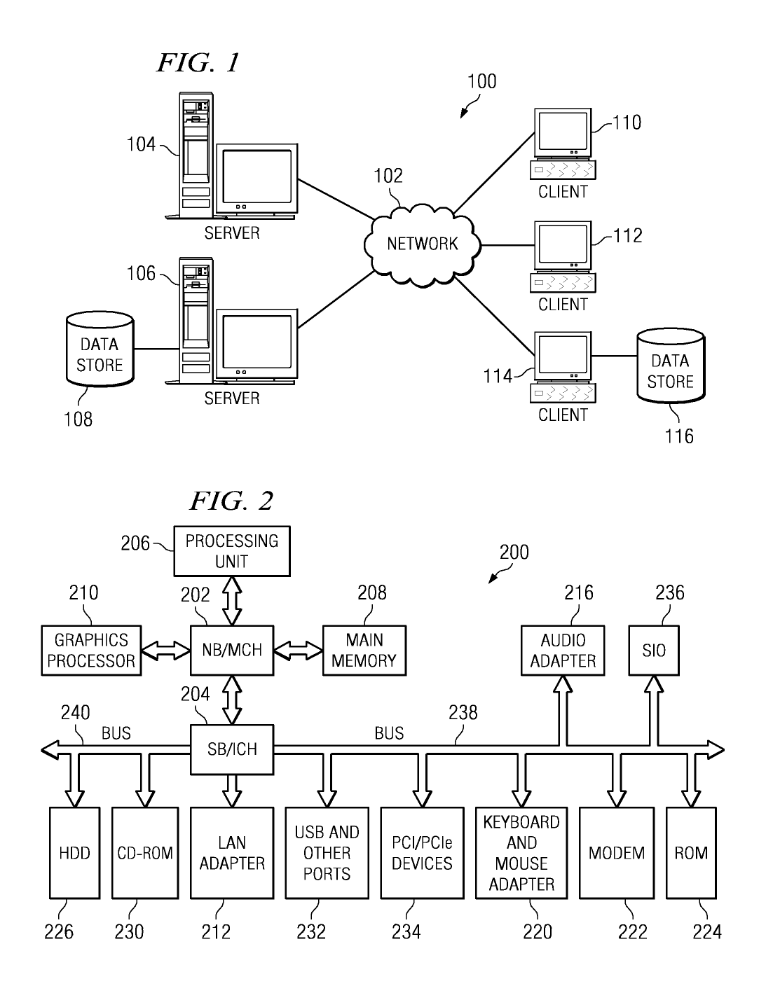

With reference now to the figures and in particular with reference to FIGS. 1-2, exemplary diagrams of data processing environments are provided in which exemplary embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which exemplary embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102. Server 104 and server 106 may include a data store, such as data store 108. In this illustrative example, data store 108 is associated with server 106. In addition, clients 110, 112, and 114 connect to network 102. Clients 110, 112, and 114 may be, for example, personal computers or network computers. Clients 110, 112, and 114 may also include a data store, such as data store 116. In the depicted example, clients 110, 112, and 114 are clients to server 106. For example, server 106 may provide data, such as, but not limited to, boot files, operating system images, and applications to clients 110, 112, and 114. Network data processing system 100 may include additional servers, clients, and other devices not shown.

The illustrative embodiments may be implemented in a data processing system such as client 110. Client 110 may be part of the information technology infrastructure of an organization. Client 110 may be monitored by a systems management system, such as, but not limited to, Tivoli® Business Systems Manager (TBSM), Tivoli® Enterprise Console (TEC), NetView®, and HP OpenView®. Tivoli® Business Systems Manager, Tivoli® Enterprise Console, and NetView® are registered trademarks of International Business Machines Corporation. HP OpenView® is a registered trademark of Hewlett-Packard Development Company, L.P.

The illustrative embodiments of the present invention recognize that it would be useful for operation personnel, as well as business executives, monitoring the systems management system to be aware of reported problems associated with the information technology infrastructure of the organization. Therefore, the illustrative embodiments described herein provide a computer implemented method, apparatus, and computer program product for exposing information technology service management problems associated with a particular data processing system to a systems management system. In this illustrative example, client 110 receives a ticket identifier. The ticket identifier identifies a reported problem associated with client 110. The ticket identifier is generated and stored on client 110.

The ticket identifier may be generated and stored on client 110 in accordance with, but not limited to, the illustrative embodiments of related application, “Method and Apparatus for Associating Help Desk Ticket with Affected Data Processing System.” For example, in this illustrative example, client 114 may be a help desk system. Client 114 generates a help desk ticket comprising of information associated with a reported problem related to a particular data processing system, such as client 110 in this illustrative example. The help desk ticket or a ticket identifier that identifies the reported problem may be stored on client 114 in a data store, such as data store 116. Alternatively, the help desk ticket or ticket identifier may be stored in a data store associated with a server, such as data store 108 and server 106. In this illustrative example, the ticket identifier is sent from the help desk system to client 110 via network 102.

In response to client 110 receiving the ticket identifier, a systems management system associated with client 110 is indentified. A message, containing the reported problem associated with client 110, is generated. The message is formatted to comply with standards of the identified systems management system. The message is sent to the systems management system. In another illustrative embodiment, a message may be generated in response to receiving an updated ticket identifier, wherein the updated ticket identifier contains information associated with the resolution of the reported problem.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different exemplary embodiments.

With reference now to FIG. 2, a block diagram of a data processing system is shown in which exemplary embodiments may be implemented. Data processing system 200 is an example of a data processing system, such as server 104 or client 110 in FIG. 1, in which computer usable program code or instructions implementing the processes may be located for the exemplary embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the exemplary embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

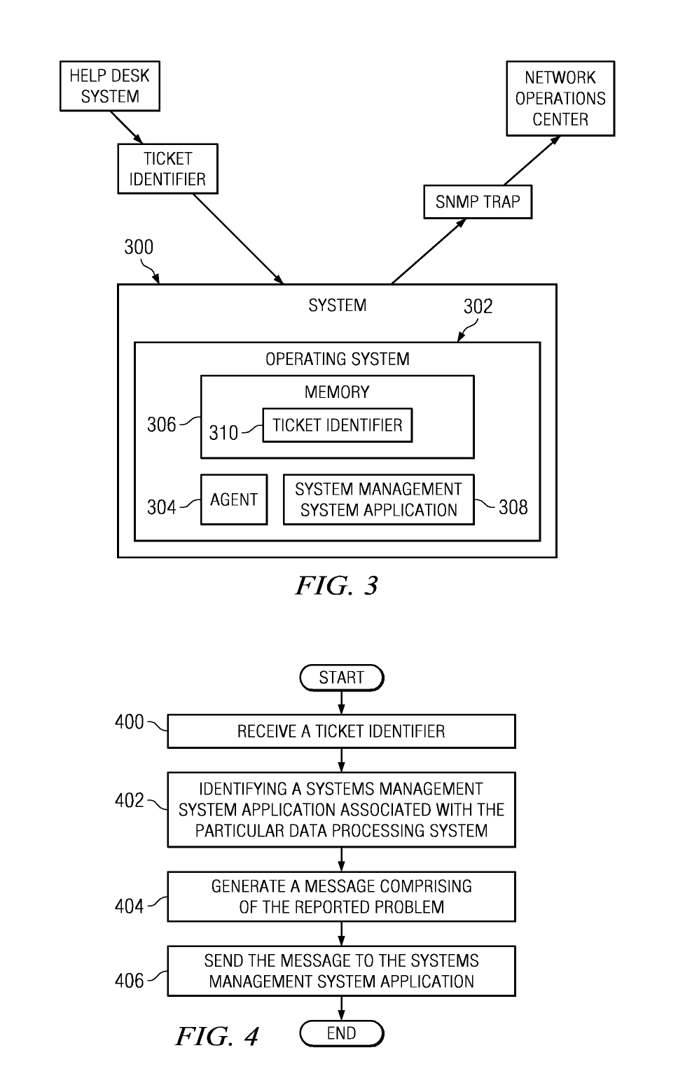

With reference now to FIG. 3, a block diagram of a data processing environment is depicted in which illustrative embodiments may be implemented. System 300 may be implemented in a data processing system, such as a server 104 or client 114 shown in FIG. 1, or data processing system 200 shown in FIG. 2. System 300 includes, among other components, operating system 302, agent 304, memory 306, and systems management system application 308. Memory 306 may be any type of memory used for storing data, such as, but not limited to, main memory 208 and read only memory (ROM) 224 as shown in FIG. 2. Memory 306 stores a ticket identifier, such as ticket identifier 310.

Operating system 302 runs on system 300. Operating system 302 may be, but is not limited to, any commercially available operating system, such as, for example, Microsoft® Windows Server® operating system. The illustrative embodiments may be implemented in an agent, such as agent 304 running on operating system 302. Additionally, operating system 302 may run other software components or applications.

Responsive to receiving a ticket identifier, agent 304 stores to ticket identifier into memory, such as ticket identifier 310 stored in memory 306. Additionally, responsive to receiving the ticket identifier, agent 304 identifies a systems management system application associated with system 300, such as systems management system application 308. The systems management system application may be identified using exiting configuration knowledge and/or signature scanning. Signature scanning involves scanning for known identifiable code associated with a particular systems management system application.

Agent 304 generates a message. The message includes the reported problem associated with system 300. The message is sent, via a simple network management protocol (SNMP) trap, to the systems management system. Simple network management protocol is a protocol-based network management system. Simple network management protocol traps enable an systems management system agent executing on the asset to notify the systems management system of events by way of an unsolicited simple network management protocol message. For example, simple network management protocol provides the ability to send traps, or notifications, to advise an administrator when one or more conditions have been met. Traps are network packets that contain data relating to a component of the system sending the trap. The data may be statistical in nature or even status related.

The systems management system may generate an alert or a report based on the received message. The systems management system application may be monitored by a network operations center (NOC). Personnel at the network operations center may forward the message to other systems management system applications. Therefore, operation personnel, as well as business executives, monitoring the systems management system are made aware of reported problems associated with the information technology infrastructure of the organization and may take appropriate actions.

With reference now to FIG. 4, a flowchart of a process for exposing information technology service management problems to a systems management system is depicted in accordance with an illustrative embodiment. The process of FIG. 4 may be implemented in a software component, such as agent 304 as shown in FIG. 3.

The process begins by receiving a ticket identifier (step 400). The ticket identifier identifies a reported problem associated with the particular data processing system. Responsive to receiving the ticket identifier, the process identifies a systems management system application associated with the particular data processing system (step 402). The process generates a message comprising of the reported problem associated with the particular data processing system (step 404). The process sends the message to the systems management system application (step 406), with the process terminating thereafter.

Accordingly, the illustrative embodiments described herein provide a computer implemented method, apparatus, and computer program product for exposing information technology service management problems associated with a particular data processing system to a systems management system. A ticket identifier is received by a data processing system. The ticket identifier identifies a reported problem associated with the data processing system. Responsive to receiving the ticket identifier, the data processing system identifies a systems management system application associated with the data processing system. A generated message containing the reported problem associated with the data processing system is sent to the systems management system.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for exposing information technology service management problems associated with a particular data processing system to a systems management system application, the computer implemented method comprising:
receiving, at the particular data processing system, a ticket identifier, wherein the ticket identifier identifies a reported problem associated with the particular data processing system;
responsive to receiving the ticket identifier, identifying a systems management system application associated with the particular data processing system;
generating a message, wherein the message includes the reported problem associated with the particular data processing system; and
sending the message to the systems management system application, wherein the reported problem associated with the particular data processing system is exposed to the systems management system application.

2. The computer implemented method of claim 1, wherein the message is sent using a simple network management protocol (SNMP) trap.

3. The computer implemented method of claim 1, wherein the reported problem is stored locally on the particular data processing system.

4. The computer implemented method of claim 1, wherein the reported problem is stored on a remote data processing system and is retrieved using the ticket identifier.

5. The computer implemented method of claim 1, wherein the systems management system application is monitored by a network operations center.

6. The computer implemented method of claim 5, wherein personnel at the network operations center forwards the message to a second systems management system application.

7. The computer implemented method of claim 1, wherein the message is formatted to comply with standards of the systems management system application.

8. The computer implemented method of claim 1, wherein the systems management system application generates an alert in response to receiving the message.

9. A computer program product comprising:
a computer usable medium including computer usable program code for exposing information technology service management problems associated with a particular data processing system to a systems management system application, the computer program product comprising:
computer usable program code for receiving, at the particular data processing system, a ticket identifier, wherein the ticket identifier identifies a reported problem associated with the particular data processing system;
computer usable program code for identifying a systems management system application associated with the particular data processing system in response to receiving the ticket identifier;
computer usable program code for generating a message, wherein the message includes the reported problem associated with the particular data processing system; and
computer usable program code for sending the message to the systems management system application, wherein the reported problem associated with the particular data processing system is exposed to the systems management system application.

10. The computer program product of claim 9, wherein the message is sent using a simple network management protocol (SNMP) trap.

11. The computer program product of claim 9, wherein the reported problem is stored locally on the particular data processing system.

12. The computer program product of claim 9, wherein the reported problem is stored on a remote data processing system and is retrieved using the ticket identifier.

13. The computer program product of claim 9, wherein the systems management system application is monitored by a network operations center.

14. The computer program product of claim 13, wherein personnel at the network operations center forwards the message to a second systems management system application.

15. The computer program product of claim 9, wherein the message is formatted to comply with standards of the systems management system application.

16. The computer program product of claim 9, wherein the systems management system application generates an alert in response to receiving the message.

17. An apparatus comprising:
a bus system;
a communications system connected to the bus system;
a memory connected to the bus system, wherein the memory includes computer usable program code; and
a process unit connected to the bus system, wherein the process unit executes the computer usable program code to receive, at a particular data processing system, a ticket identifier, wherein the ticket identifier identifies a reported problem associated with the particular data processing system; identify a systems management system application associated with the particular data processing system in response to receiving the ticket identifier; generate a message, wherein the message includes the reported problem associated with the particular data processing system; and send the message to the systems management system application, wherein the reported problem associated with the particular data processing system is exposed to the systems management system application.

18. The apparatus of claim 17, wherein the message is sent using a simple network management protocol (SNMP) trap.

19. The apparatus of claim 17, wherein the reported problem is stored locally on the particular data processing system.

20. The apparatus of claim 17, wherein the reported problem is stored on a remote data processing system and is retrieved using the ticket identifier.
